(19) United States
(12) Patent Application Publication
(10) Pub. No.: US 2010/0250289 A1
(43) Pub. Date: Sep. 30, 2010

(54) CONSUMER CLAIM MANAGEMENT PROCESS

(75) Inventor: TROY DAVID WEAVER, Leighton, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/620,837

(22) Filed: Nov. 18, 2009

Related U.S. Application Data
(60) Provisional application No. 61/116,731, filed on Nov. 21, 2008.

(51) Int. Cl. G06Q 40/00; G06Q 50/00; G06Q 10/00

(52) U.S. Cl. 705/4

(57) ABSTRACT

The present invention is directed to a process for managing claims to repair an article of a customer. The present invention is particularly directed to a process for managing claims to repair an article of a customer when the article is covered by an insurance policy. This invention is further directed to a process for managing claims to repair an automobile vehicle of a customer covered by an insurance policy having a predetermined deductable.

### FIELD OF INVENTION

The present invention is directed to process for managing claims to repair an article of a customer. The present invention is particularly directed to a process for managing claims to repair an article of a customer when the article is covered by an insurance policy. This invention is further directed to a process for managing claims to repair an automobile vehicle of a customer covered by an insurance policy having a predetermined deductable.

### BACKGROUND OF INVENTION

Current automobile vehicle insurance system usually sets a pre-determined monetary amount of “deductable” that has to be paid by a customer who holds an insurance policy covering the vehicle. Any amount, up to a certain limit, for vehicle repair that is exceeding the deductable is usually paid for by the insurance company according to the insurance policy. Since the customer is typically not paying for the amount exceeding the deductable, the customer has no incentive to reduce vehicle repair cost even if lower cost alternatives are readily available with equal quality leading to higher repair costs. The insurance company then charges the customer higher premium to cover the higher repair costs. Such system leads to ever increasing insurance costs.

Currently, there is no process or method to provide a customer incentive for reducing car repair costs.

### STATEMENT OF INVENTION

This invention is directed to a process for managing claims to repair an article of a customer, said process comprising the steps of:
(i) authorizing the customer to access a claim management system through a computing device based on identification data of the customer, wherein the customer holds an insurance policy from an insurance company;
(ii) obtaining damage data of the article, wherein said article is covered by said insurance policy;
(iii) retrieving a repair deductable according to the insurance policy from an insurance database accessible from the computing device;
(iv) generating and displaying repair data on a display device coupled to the computing device, said repair data comprise standard repair cost and repair options based on the damage data and the insurance policy;
(v) obtaining repair selections from the customer on one or more of said repair options to generate a customer repair selection;
(vi) calculating a customer repair cost based on the customer repair selection;
(vii) generating a modified deductable based on the standard repair cost and the customer repair cost, wherein said modified deductable is less than said repair deductable if the customer repair cost is less than the standard repair cost;
(viii) generating a repair estimate based on said customer repair selection, said customer repair cost and said modified deductable; and
(ix) displaying on the display device said repair estimate, said customer repair cost and said modified deductable.

This invention is also directed to a computing program product stored in a computer readable storage medium, said computing program product when installed on or functionally coupled to a computing device causes the computing device to perform a computing process comprising the steps of:
(i) authorizing a customer to access the claim management system through said computing device based on identification data of the customer, wherein the customer holds an insurance policy from an insurance company;
(ii) receiving damage data of an article of the customer, wherein said article is covered by said insurance policy;
(iii) retrieving a repair deductable according to the insurance policy from an insurance database accessible from the computing device;
(iv) generating and displaying on a display device coupled to the computing device repair data comprising a repair deductable, standard repair cost, and repair options based on the damage data and the insurance policy;
(v) receiving repair selections on one or more of said repair options to generate a customer repair selection;
(vi) calculating a customer repair cost based on the customer repair selection;
(vii) generating a modified deductable based on the standard repair cost and the customer repair cost, wherein said modified deductable is less than said repair deductable if the customer repair cost is less than the standard repair cost;
(viii) generating a repair estimate based on said customer repair selection, said customer repair cost and said modified deductable; and
(ix) displaying on said display device said repair estimate, said customer repair cost and said modified deductable.

This invention is further directed to a claim management system comprising a computing program product and a computing device, said computing program product causes the computing device to perform a computing process comprising the steps of:
(i) authorizing a customer to access the claim management system through said computing device based on identification data of the customer, wherein the customer holds an insurance policy from an insurance company;
(ii) receiving damage data of an article of the customer, wherein said article is covered by said insurance policy;
(iii) retrieving a repair deductable according to the insurance policy from an insurance database accessible from the computing device;
(iv) generating and displaying on a display device coupled to the computing device repair data comprising a repair deductable, standard repair cost, and repair options based on the damage data and the insurance policy;
(v) receiving repair selections on one or more of said repair options to generate a customer repair selection;
(vi) calculating a customer repair cost based on the customer repair selection;
(vii) generating a modified deductable based on the standard repair cost and the customer repair cost, wherein said modified deductable is less than said repair deductable if the customer repair cost is less than the standard repair cost;
(viii) generating a repair estimate based on said customer repair selection, said customer repair cost and said modified deductable; and
(ix) displaying on said display device said repair estimate, said customer repair cost and said modified deductable.

### BRIEF DESCRIPTION OF DRAWING

FIG. 1 shows an example of the process of this invention.

FIG. 2 shows examples of hardware configurations of a system of this invention. (A) A system configuration with one computing device. (B) A system configuration comprising a host computer and at least one client computer.

FIG. 3 shows examples of (A) a typical log on screen and (B) a typical screen for vehicle data.

FIG. 4 shows examples of (A) Selection of repair options, (B) cost data, and (C) modified deductable shown as “Deductable Based on Your Selection on Repair Options”.

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

The term “customer” used herein refers to a person or persons, an agency, or an entity that requests repair of an article. A customer may be the owner of the article or a representative or an agent of the owner. The customer may also be a person who has temporary possession or responsibility of an article, such as a person who rents or leases a car, boat, or an airplane. The customer may also be an agency, a company, or an entity that has possession or responsibility of an article, such as a rental car company or a bank who owns a lien of a vehicle.

The term “identification data of the customer”, “data of the customer” or “customer information” refers to information related to the customer. The data can include one or more of the following, but not limited to, a first name, variations of the first name, a preferred name, a nick name, a last name, a street address, a postal box address, a telephone number, a cell phone number, a pager number, a fax number, an e-mail address, a web address, an electronic file location, a photograph, an identification number or a code assigned to the customer for identification purposes, an account number, a credit card number, an insurance policy identification, an insurance company identification, a warranty policy identification, a warranty issuer's identification, a history of previously received services, a description of previously received services, a credit history, a credit score, a name of a representative, a note, a record, or a comment of the customer. The identification number or the code assigned to the customer can include, but not limited to, an article number, an estimate number, a purchase order (PO) number, a requisition order (RO) number, and other codes or identifications typically generated by a service provider or a repair shop during its normal course of business practice for identifying a customer. Data of the customer may include customer name, address, contact information, mileage of the vehicle, license plate number, state of vehicle registration, and other information or data describing a vehicle of the customer. Data of the customer can be typed directly into a computing device via a key board or interactive input-display device, such as a touch screen coupled to the portable computing device, or imported from another computing device, a host computer or another data import member.

The term “vehicle”, “automotive”, “automobile”, “automotive vehicle”, or “automobile vehicle” refers to an automobile such as car, van, mini van, bus, SUV (sports utility vehicle); truck; semi truck; tractor; motorcycle; trailer; ATV (all terrain vehicle); pickup truck; heavy duty mover, such as, bulldozer, mobile crane and earth mover; airplanes; boats; ships; and other modes of transport.

A computing device refers to a desktop computer, a laptop computer, a pocket PC, a personal digital assistant (PDA), a handheld electronic processing device, a smart phone that combines the functionality of a PDA and a mobile phone, or any other electronic devices that can process information automatically. A computing device may have a wired or wireless connection to a database or to another computing device. A computing device may be a client computer that communicates with a host computer in a multi-computer client-host system connected via a wired or wireless network including intranet and internet. The computing device can comprise an input device selected from a digital input device, such as a wired keyboard, a wireless keyboard, a digital writing pad, a touch screen, an input portal that can be connected to an electrical device or another computer, or any other digital devices that can input data into the computing device.

A computing device can also be configured to be coupled with a data input or output device via wired or wireless connections. A computing device can have a display device, such as a monitor screen. A computing device can also be a “portable computing device” such as a laptop computer, a pocket PC, a personal digital assistant (PDA), a handheld electronic processing device, a mobile phone, a smart phone that combines the functionality of a PDA and a mobile phone, a tablet computer, or any other stand alone or subunit devices that can process information and data and can be carried by a person.

A computing device can be connected to a wired or wireless network via wired or wireless connections. Wired connections include hardware couplings, splitters, connectors, cables or wires. Wireless connections and devices include, but not limited to, Wi-Fi device, Bluetooth device, wide area network (WAN) wireless device, Wi-Max device, local area network (LAN) device, 3G broadband device, infrared communication device, optical data transfer device, radio transmitter and optionally receiver, wireless phone, wireless phone adaptor card, or any other devices that can transmit signals in a wide range of electromagnetic wavelengths including radio frequency, microwave frequency, visible or invisible wavelengths.

The term “memory member” or “memory” includes internal memory, random access memory (RAM), internal hard drive, memory card, removable memory card, flash memory card, writable or re-writable compact disk, compact disc Read-Only Memory (CD-ROM), or any other electromagnetic or optical devices that can be used to store and/or retrieve data. Some examples of removable or flash memory cards include USB flash memory, SD memory card, and memory stick.

The term “data storage medium” or “data storage device” can include: an optical memory device, such as a compact disc (also known as “CD”), DVD (also known as “Digital Versatile Disc” or “Digital Video Disc”), Blu-Ray disc (also known as “Blu-Ray” or “BD”); non-volatile computer memory devices, such as a hard drive, a portable hard drive, a flash memory card, ferroelectric RAM (FeRAM or FRAM), Magnetoresistive Random Access Memory (MRAM), conductive-bridging RAM (CBRAM), Phase-change memory (also known as PCM, PRAM, PCRAM, Ovonic Unified Memory, Chalcogenide RAM and C-RAM), SONOS (Silicon-Oxide-Nitride-Oxide-Silicon) memory, Resistive random-access memory (RRAM), IBM Racetrack Memory, Nano-RAM containing nanotubes; volatile storage device, such as random access memory (RAM), Dynamic random access memory (DRAM), DDR SDRAM (double data rate synchronous dynamic random access memory), Static random access memory (SRAM); or other electromagnetic data storage devices for storing data in various electromagnetic forms.

The term “data input device” or “input device” includes, but not limited to, a scanner, a barcode reader, an RFID (radio frequency identification device) sensor or reader, a camera, a video camera, a memory card, a memory card reader, a hard drive, a portable hard drive, a disk drive, a compact disk drive, a cell phone, a PDA, a computer, a key board, a hand-writing recognition device, an interactive input-display device, or any other devices that can input data into a computing device or a host computer. The data input device can be functionally coupled to a computing device and can also include any devices, hardware or software that is necessary for operatively coupling the data input device and the computing device.

The term “data output device” or “output device” includes, but not limited to, a printer, a fax machine, a memory card, a memory card writer, a hard drive, a portable hard drive, a disk drive, a writable compact disk drive, a cell phone, a PDA, a computer, or any other devices that can output data from a computing device or a host computer. The data output device can be functionally coupled to a computing device and can also include any devices, hardware or software that is necessary for operatively coupling the data output device and the computing device.

The term “network device” or “connection device” includes wired or wireless communication devices that enable the computing device to communicate with one or more electronic devices, such as an input device, an output device, or a host computer, through wired or wireless connections. “Wired communication devices” or “wired connections” include hardware couplings, splitters, connectors, cables or wires. “Wireless communication devices” or “wireless connections and devices” include, but not limited to, Wi-Fi device, Bluetooth device, wide area network (WAN) wireless device, Wi-Max device, local area network (LAN) device, 3G broadband device, infrared communication device, optical data transfer device, radio transmitter and optionally receiver, wireless phone, wireless phone adaptor card, or any other devices that can transmit signals in a wide range of electromagnetic wavelengths including radio frequency, microwave frequency, visible or invisible wavelengths. The network device can also provide wired or wireless connections to couple one or more data input or data output devices to the computing device.

A display device can be a computer monitor, a projector, a TV screen, a personal digital assistant (PDA) device, a display screen of a digital camera, a cell phone, a smart phone that combines some functionality of a PDA and a cell phone, an iPod, an iPod/MP Player, a flexible thin film display, or any other devices that can display information or images based on digital signals. The display device can also be a printing device that prints, based on digital signals, information or image onto papers, plastics, textiles, or any other surfaces that are suitable for printing the information or images onto. The display device can also be a duel functional display/data input device, such as a touch screen.

The term “database” refers to a collection of related information that can be searched and retrieved. The database can be a searchable electronic numerical, alphanumerical or textual document; a searchable PDF document; a Microsoft Excel® spreadsheet; a Microsoft Access® database (both available from Microsoft Corporation of Redmond, Wash.); an Oracle® database (available from Oracle Corporation of Redwood Shores, Calif.); or a Linux database, each registered under their respective trademarks. The database can be a set of electronic documents, photographs, images, diagrams, or drawings, residing in a computer readable storage media that can be searched and retrieved. A database can be a single database or a set of related databases or a group of unrelated databases. “Related database” means that there is at least one common information element in the related databases that can be used to relate such databases. Examples of the related databases can include Oracle® relational databases. A database can contain information such as user names, user identifications (IDs), passwords, and other data.

As used herein “vehicle identification number” or “VIN” refers to a string of alphanumeric characters used by vehicle manufacturers to identify each vehicle. Different vehicles may have different VIN systems. VINs are currently used by all vehicle manufacturers to record relevant information about the vehicle, such as make, model, model year, site of manufacture, production sequence, etc. In most countries today, VINs are required by law. For example, the U.S. government currently requires all cars and trucks made for sale in U.S. to carry a 17-character vehicle identification number (Federal Register, Vol. 61, No. 111, Rules and Regulations, Page 29031-29036, Jun. 7, 1996).

“Vehicle data” used herein can include make, model, model year, vehicle body style, site of manufacture, production sequence, and other information of the vehicle that are provided by a vehicle manufacturer, which can be retrieved based on the VIN. The vehicle data also include other data, such as refinish coating formulations, instructions on repair process and materials that are developed by vehicle manufacturers, refinish coating providers, or vehicle parts suppliers. The vehicle data can further include one or more diagrams of a vehicle specific to vehicle body style that can be identified based on the VIN. The vehicle diagram can be retrieved from a database based on the vehicle body style identified by the VIN. The vehicle diagram can also be generated dynamically based on vehicle body style identified by the VIN by a computing device and stored in a temporary database. For example, if the VIN indicates that vehicle body style of the vehicle for repair is a sedan, then a diagram of a sedan can be retrieved as part of the vehicle data. The database containing vehicle diagrams can be operatively residing in a computing device used for this invention or in other computer or computing device, such as a host computer operatively communicating with the computing device. The database containing vehicle diagrams can also be part of another database.

The term “defect” or “damage” used herein refers to structural or non-structural damages on a vehicle. The non-structural defects may include coating defects, dents on a vehicle body, vehicle interior surface and finish damages, glass and windshield damages, vehicle exterior surface damages, or combinations thereof. Structural damages can include those damages to one or more portions of a vehicle. The defects may further include flaws and other visible defects of the vehicle that are caused by mechanical or chemical actions or by atmospheric conditions, e.g., hail or acid rain, or by vandalism. The defects can further include those caused by defective workmanship of manufacturing, material failure, or design flaws. The defect can even include those structural or non-structural portions of a vehicle that fail to comply with regulatory mandates. The term “damage data” refers to a collection of information or data of the damage.

The term “repair data” refers to a collection of information necessary for repairing the damage. The repair data can include the aforementioned vehicle data if the article to be repaired is a vehicle. The repair data can also include the damage data.

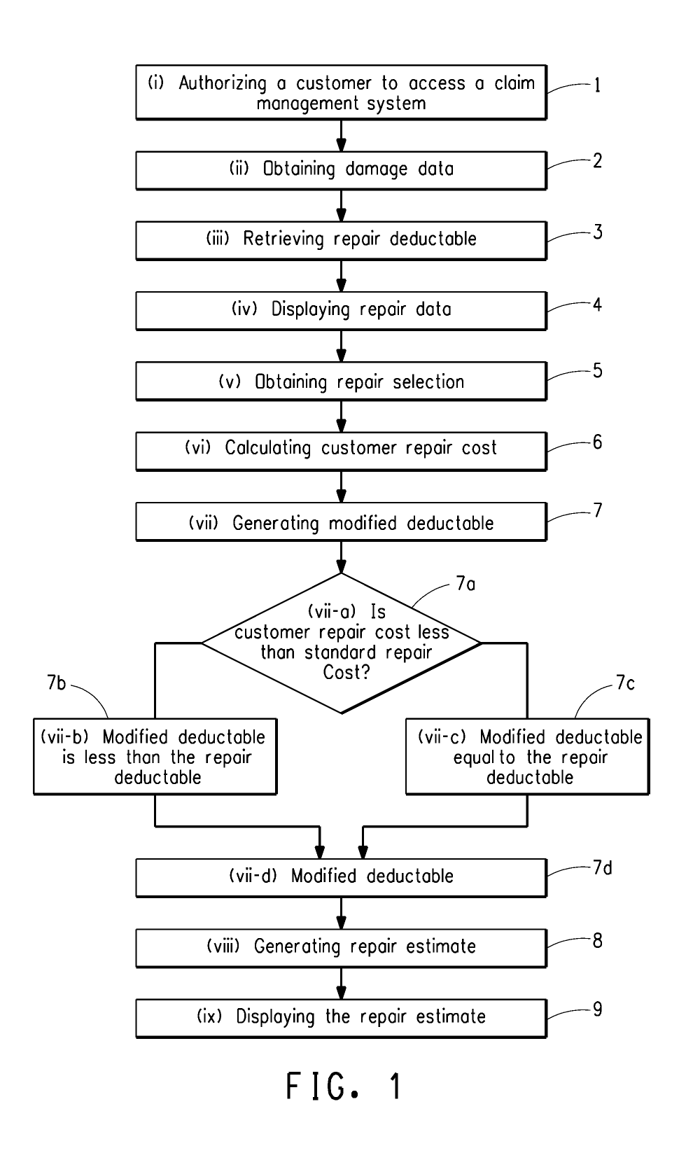

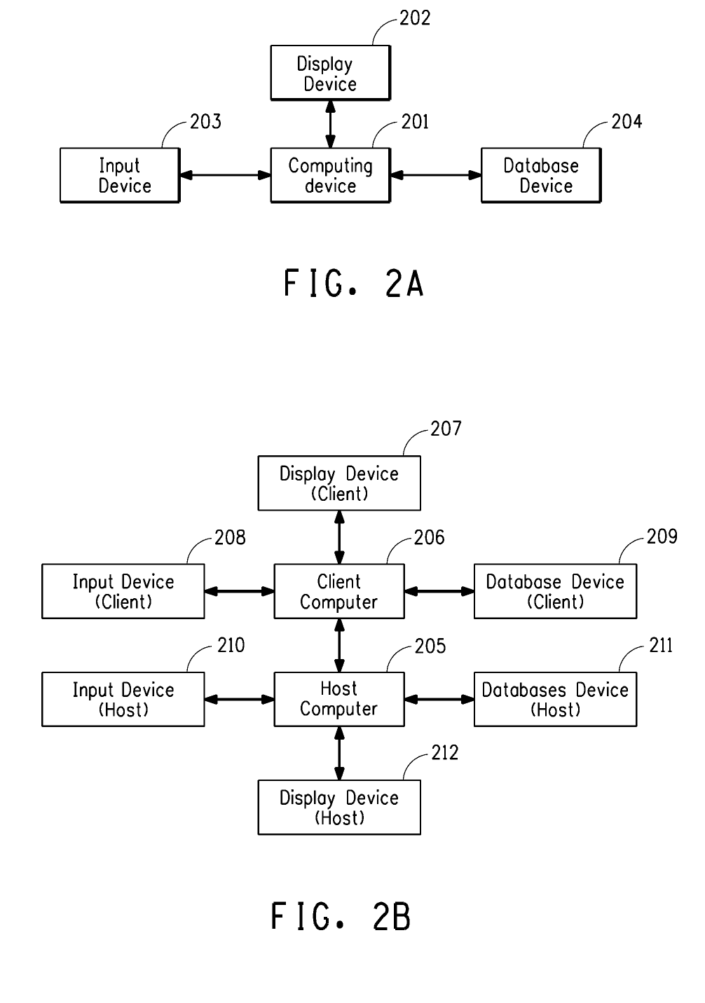

This invention is directed to a process for managing claims to repair an article of a customer. The process can comprise the steps of (FIG. 1):
(i) authorizing the customer to access a claim management system through a computing device based on identification data of the customer, wherein the customer holds an insurance policy from an insurance company (1);
(ii) obtaining damage data of the article, wherein said article is covered by said insurance policy (2);
(iii) retrieving a repair deductable according to the insurance policy from an insurance database accessible from the computing device (3);
(iv) generating and displaying repair data on a display device coupled to the computing device, said repair data comprise standard repair cost and repair options based on the damage data and the insurance policy (4);
(v) obtaining repair selections from the customer on one or more of said repair options to generate a customer repair selection (5);
(vi) calculating a customer repair cost based on the customer repair selection (6);
(vii) generating a modified deductable based on the standard repair cost and the customer repair cost, wherein said modified deductable is less than said repair deductable if the customer repair cost is less than the standard repair cost (7, 7a, 7b, 7c and 7D);
(viii) generating a repair estimate based on said customer repair selection, said customer repair cost and said modified deductable (8); and
(ix) displaying on the display device said repair estimate, said customer repair cost and said modified deductable (9).

The customer can be authorized to access the claim management system by providing certain identification data, such as user ID and password. In one example, the customer can login to the system from a computer connected to a host computer through internet connection using his user ID and password. The identification data such as the use ID and password can be pre-assigned to the customer by the system or by the insurance company that the customer holds an insurance policy, or can be obtained by the customer through a registration process that can be part of the claim management system of this invention.

Damage data can include a description or category description, severity, location, size and other descriptive data of a defect. The damage data can be used for estimating repair costs. In one example, damage date on a dent can include the size, location and severity of the dent. In another example, damage data can include part number of an engine that need to be replace in a vehicle. The damage data can be entered by the customer and verified by the insurance company, or entered by an agent of the insurance company. In one example, windshield of a vehicle of a customer is damaged. The customer can report the damage by entering the damage data into the claim management system through a web interface. Typically, other data about the vehicle, such as make, model, VIN, etc are already stored in an insurance database that the claim management system can access. In another example, after the customer reports damage to the insurance company, an agent of the insurance company assesses the damage and enters the damage data into the system.

The damage data can also include paint data. The paint data can comprise color name, color code, texture, appearance, color measurement data, or any other data that identify the nature or color of the paint on the article. Color name can be descriptions of color, such as blue or red. Color code can be identifications of color used by manufacturers, such as color code typically used by car manufacturers. Texture and appearance of paint can be those descriptions of paint describing special visual effects of the paint, such silver metallic, or matt metallic, etc. Texture and appearance of paint can also include appearance measurement data, such as metallic flake data, obtained from an appearance measurement device. Color measurement data can include spectral data obtained from a color measuring device such as a spectrophotometer. The paint data, specifically the color data, can be used to repair paint of the article to match the original paint on the article. Paint data can be entered by the customer, repair shop, or a combination thereof. For example, a color name can be entered by the customer, while color code or spectrophotometer data can be entered by a repair shop.

Based on the damage data, the system can retrieve and display repair data on a display device such as a computer monitor. The repair data can comprise repair deductable, standard repair cost, and repair options based on the damage data and the insurance policy that the customer holds. The repair deductable is typically defined in the insurance policy that the customer holds which is typically a few hundred dollars that have to be paid by the customer. The standard repair cost can be calculated based on the damage data. For example, the cost for replacing a damaged windshield can be calculated based on vehicle make, model, or VIN. Typically, there can be more than one repair options for repairing that particular damage, or a set of damages.

The repair options can comprise one or more options selected from: repair shop selection, repair part selection, article rental selection, or a combination thereof

The repair options can include a list of items or parts that the customer can select from to repair the vehicle. In one example, the damage data can include two damaged wheels of a vehicle needing to be repaired. The repair options can include: a) repairing the damaged wheels, b) replacing the damaged wheels with a set of OEM wheels provided by original equipment manufacturer (OEM), c) replacing the damaged wheels with a set of used wheels recovered from other vehicles that meet the specifications of the original wheels, and d) replacing the damaged wheels with a set of new aftermarket generic wheels that meet the original specifications. For the option d), the system can further display different generic aftermarket wheels, such as different brands, that all meet the original specifications, but have different prices.

The customer can enter his/her selections on one or more repair options. In one example, the customer can make his/her selections by clicking on appropriate buttons or check marks on an online form displayed on a computer screen that are capable of transmitting the selection to the claim management system of this invention. Based on the selection, the system can generate the customer repair selection and calculate the customer repair cost.

The modified deductable can be calculated based on the standard repair cost and the customer repair cost (7a, 7b, 7c, and 7d).

If the customer repair cost (Cₘ) is below the repair cost (Cₛ), the modified deductable (Dₘ) can be less than the repair deductable (Dₛ) based on the following formulation:

Dₘ=Dₛ−k(Cₛ−Cₘ) (1)

Wherein k is a modification factor predetermined by the insurance company and can be in a range of from 0.01 to 2. In one example, k can be in a range of from 0.01 to 1.5. In another example, k can be in a range of from 0.01 to 1.0. For example, when the customer selects the brand B aftermarket wheels in the repair option that cost $50 less than the cost of the brand A in standard repair, the modified deductable (Dₘ) can be $50 less than the repair deductable (Dₛ) when k is predetermined as 1. In the same example, the modified deductable (Dₘ) can be $25 less than the repair deductable (Dₛ) when k is predetermined as 0.5.

If more than one item is to be repaired, the modified deductable (Dₘ) can be calculated based on a sum of the total standard repair costs (ΣCₛ) and a sum of the customer repair costs (ΣCₘ) using the following formulation:

Dₘ=Dₛ−k(ECₛ−ΣCₘ) (2).

The process can also be configured to calculate modified deductable using the following formulation (3) based on individual standard repair cost (Cₛ₁ to Cₛₙ) and individual customer repair cost (Cₘ₁ to Cₘₙ) for individual item and each item can have individual modification factor (k₁ to kₙ) predetermined by the insurance company:

Dₘ=Dₛ−k₁(Cₛ₁−Cₘ₁)−k₂(Cₛ₂−Cₘ₂) . . . −kₙ(Cₛₙ−Cₘₙ) (3)

Wherein k₁, k₂ . . . kₙ can be in a range of from 0.01 to 2, and can be the same or different. With individual modification factors k₁, k₂ . . . kₙ, the formulation (3) can provide flexibility in repair options.

The repair options can also include different repair shops that have different repair specialties or expertise, or repair shops in different areas that can have different repair costs. For example, a customer can choose to use a car dealer specialized in a particular make of the vehicle for certain major damages that need repair. The customer can choose to use an independent vehicle repair shop for minor damages. Optionally, the customer can choose to use a combination of different repair shops for repairing different types of damages, or choose to authorize one repair shop to handle the repair process on his/her behalf when a major repair can involve more than one repair shops. For example, the customer can choose to authorize a first repair shop to repair some of the vehicle body frame damages, to send the vehicle to a second repair shop to repair engine damages, and to send the vehicle to a third repair shop to repair coating damages.

The repair shop selection can list the names or locations of available repair shops. In one example, the available repair shops can be selected from: (1) any Network repair shop associated or affiliated with the insurance company; (2) a specific Network repair shop; (3) any Non-network repair shop that is not associated or affiliated with the insurance company; and (4) a specific Non-Network repair shop.

The repair shops can be listed or searched based on location indicators, such as names of street, city and state, or a zip code. The repair shops can also be listed or searched based on name or partial name of the repair shop, or by name or partial name of the owner of the repair shop. The repair shops can also be listed or searched based on repair specialty, such as paint, glass, engine, body frame, upholstery, and electronics, etc.

The article rental selection can comprise a list of articles that can be rented as a temporary replacement for the customer when the article of the customer is being repaired. For example, when a vehicle is damaged and is being repaired, the customer can typically obtain a rental vehicle. Typically, the rental vehicle can be a vehicle similar to the damaged vehicle, in terms of size, function and value. For example, if a vehicle being repaired is a midsize car, a rental car can typically be a similar midsize car of the same or different make with same or different mode year, color, or equipments, etc.

The process of this invention can be configured to require each of the customer repair costs be less than corresponding standard individual repair cost. The system can also be configured to allow that some of the customer repair costs are greater than, while other customer repair costs are less than, the corresponding standard repair costs provided that the sum of the customer repair costs is equal to or less than the sum of the standard repair costs.

If the customer repair cost (Cₘ) is equal to or higher than the repair cost (Cₛ), the modified deductable (Dₘ) can be set to equal to the repair deductable (Dₛ) (7c) or other values determined appropriate by the insurance company. If the modified deductable Dₘ is greater than the repair deductable Dₛ, the insurance company can charge the customer extra out-of-pocket cost to cover the difference. For example, if a customer selects a new OEM part that costs $550, the insurance company may charge the customer the repair deductable Dₛ of $500 plus an extra $50 out-of-pocket cost if k is predetermined as 1. The insurance company can predetermine the values of any aforementioned k, or k₁−kₙ.

The repair estimate can be generated based on the customer repair selection, the customer repair cost, and the modified deductable. The repair estimate can comprise the damage data, the customer repair selection, the customer repair cost, the modified deductable, and optionally difference between the repair deductable and the modified deductable. The repair estimate can further comprise one or more additional items selected from a damage identification that is generated by the system to identify the damage, a scheduled repair time if such repair time is scheduled, some or all of the identification data of the customer, or comments and requests entered by the customer, repair shop or the insurance company.

The process of this invention can further comprise one or more steps selected from:
(x) sending the repair estimate to a repair shop, an agent of the repair shop, the insurance company, an agent of the insurance company, the customer, an agent of the customer, or a combination thereof;
(xi) obtaining a repair report from the repair shop and optionally sending said repair report to the customer;
(xii) obtaining an insurance claim report from the insurance company and optionally sending the insurance report to said customer;
(xiii) generating a part list based on the customer repair selection and sending the part list to one or more part suppliers;
(xiv) generating an article rental request if such a rental is available in the repair option and the customer selects one option in the customer repair selection, and sending the article rental request to a rental company, such as a vehicle rental company;
(xv) obtaining a rental report from said rental company and optionally sending the rental report to said customer;
(xvi) obtaining repair approval from said insurance company; or
(xvii) a combination thereof.

In one example, the damage data comprise coating damage data of a vehicle.

In another example, a customer chooses a rental car that is more expensive than a standard rental car set forth in his insurance policy, and the repair estimate displays the portion of the rental cost that is not covered by the insurance policy and is to be paid for by the customer.

This invention is also directed to a computing program product stored in a computer readable storage medium, said computing program product when installed on or functionally coupled to a computing device can cause the computing device to perform a computing process comprising the steps of:
(i) authorizing a customer to access the claim management system through said computing device based on identification data of the customer, wherein the customer holds an insurance policy from an insurance company;
(ii) receiving damage data of an article of the customer, wherein said article is covered by said insurance policy;
(iii) retrieving a repair deductable according to the insurance policy from an insurance database accessible from the computing device;
(iv) generating and displaying on a display device of the computing device repair data comprising a repair deductable, standard repair cost, and repair options based on the damage data and the insurance policy;
(v) receiving repair selections on one or more of said repair options to generate a customer repair selection;
(vi) calculating a customer repair cost based on the customer repair selection;
(vii) generating a modified deductable based on the standard repair cost and the customer repair cost, wherein said modified deductable is less than said repair deductable if the customer repair cost is less than the standard repair cost;
(viii) generating a repair estimate based on said customer repair selection, said customer repair cost and said modified deductable; and
(ix) displaying on said display device said repair estimate, said customer repair cost and said modified deductable.

The computing process can further comprise one or more steps selected from:
(x) sending the repair estimate to a repair shop, an agent of the repair shop, the insurance company, an agent of the insurance company, the customer, an agent of the customer, or a combination thereof;
(xi) obtaining a repair report from the repair shop and optionally sending said repair report to the customer;
(xii) obtaining an insurance claim report from the insurance company and optionally sending the insurance report to said customer;
(xiii) generating a part list based on the customer repair selection and sending the part list to one or more part suppliers;
(xiv) generating an article rental request based on the customer repair selection and sending the article rental request to a rental company;
(xv) obtaining a rental report from said rental company and optionally sending the rental report to said customer;
(xvi) obtaining repair approval from said insurance company; or
(xvii) a combination thereof.

The computing program product can be stored in any of the aforementioned computer readable storage medium. In one example, the computing program product is stored on a CD. In another example, the computing program product is stored on a DVD. In yet another example, the computing program product is stored on a portable flash USB drive. In further another example, the computing program product is stored on a hard drive of a computer. In even further another example, the computing program product is stored on a hard drive of a host computer and can be downloaded through a network connection, such as internet or cell phone connection.

This invention is further directed to a claim management system comprising a computing program product and a computing device, said computing program product when installed on or functionally coupled to the computing device can cause the computing device to perform a computing process comprising the steps of:
(i) authorizing a customer to access the claim management system through said computing device based on identification data of the customer, wherein the customer holds an insurance policy from an insurance company;
(ii) receiving damage data of an article of the customer, wherein said article is covered by said insurance policy;
(iii) retrieving a repair deductable according to the insurance policy from an insurance database accessible from the computing device;
(iv) generating and displaying on a display device of the computing device repair data comprising a repair deductable, standard repair cost, and repair options based on the damage data and the insurance policy;
(v) receiving repair selections on one or more of said repair options to generate a customer repair selection;
(vi) calculating a customer repair cost based on the customer repair selection;
(vii) generating a modified deductable based on the standard repair cost and the customer repair cost, wherein said modified deductable is less than said repair deductable if the customer repair cost is less than the standard repair cost, and wherein said modified deductable is equal to the repair deductable if the customer repair cost is equal to or greater than the standard repair cost;
(viii) generating a repair estimate based on said customer repair selection, said customer repair cost and said modified deductable; and
(ix) displaying on said display device said repair estimate, said customer repair cost and said modified deductable.

The computing process of the claim management system can further comprise one or more steps selected from:
(x) sending the repair estimate to a repair shop, an agent of the repair shop, the insurance company, an agent of the insurance company, the customer, an agent of the customer, or a combination thereof;
(xi) obtaining a repair report from the repair shop and optionally sending said repair report to the customer;
(xii) obtaining an insurance claim report from the insurance company and optionally sending the insurance report to said customer;
(xiii) generating a part list based on the customer repair selection and sending the part list to one or more part suppliers;
(xiv) generating an article rental request based on the customer repair selection and sending the article rental request to a rental company;
(xv) obtaining a rental report from said rental company and optionally sending the rental report to said customer;
(xvi) obtaining repair approval from said insurance company; or
(xvii) a combination thereof.

Any of the aforementioned storage medium can be suitable for the system of this invention.

The computing device of the claim management system can be a client computing device functionally communicating with a host computing device through a network device. The computing device can be any of the aforementioned portable computing device.

The network device of the claim management system can be selected from a wired network device, a wireless network device, any of the aforementioned network device, or a combination thereof.

The computing program product of the claim management system can reside on a memory device of the host computing device.

The claim management system can further comprising one or more databases comprising data of insurance companies, insurance policies, and deductibles related to said insurance policies, wherein said databases are accessible from said computing device.

The repair data of the claim management system can further comprise the identification data of the customer.

In one example of suitable configurations, the system can comprise a computing device (201), such as a desk top computer, laptop, or a PDA wherein said computing device can have an input device (203) such as a key board or a touch screen, and an output device such as a display device (202) such as a monitor or a printer.

In another example of suitable configurations, the system can comprise one or more client computers (206), such as a home computer or a computer in a repair shop; a host computer (205), wherein the client computers and the host computer are functionally coupled vie network devices such as internet connection devices and network or intranet connection devices and network. The client computer can have input device (208), display device (207) and optionally a local database device (209) for storing data on the client computer. The host computer can comprise an input device (210), a display device (212) and a host database device (211) for storing data on the host computer. The database device on the host can be configured to be accessible directly from the client computer via network devices or be accessible via the host computer.

The claim management system of this invention can be provided by a repair shop, an insurance company, an agent of an insurance company, an independent claim management service entity, or any entity affiliated to the repair shop, the insurance company, the agent of the insurance company.

Based on the disclosure herein, those with ordinary skill in the art can modify or reconfigure any configurations of the system without departing from the scope and spirit of this invention.

Although vehicle repairs are specifically described herein, this invention can also be used for repairing other articles. Some examples of such articles can include, but not limited to: houses; office buildings; home or office appliances, such as refrigerators, washing machines, dishwashers, microwave ovens, cooking and baking ovens; electronic appliances, such as television sets, computers, electronic game sets, audio and video equipments; recreational equipments, such as bicycles, ski equipments, all terrain vehicles; and home or office furniture, such as tables and file cabinets.

### EXAMPLES

The present invention is further defined in the following Examples. It should be understood that these Examples are given by way of illustration only. From the above discussion and these Examples, one with ordinary skill in the art can ascertain the essential characteristics of this invention, and without departing from the spirit and scope thereof, can make various changes and modifications of the invention to adapt it to various uses and conditions.

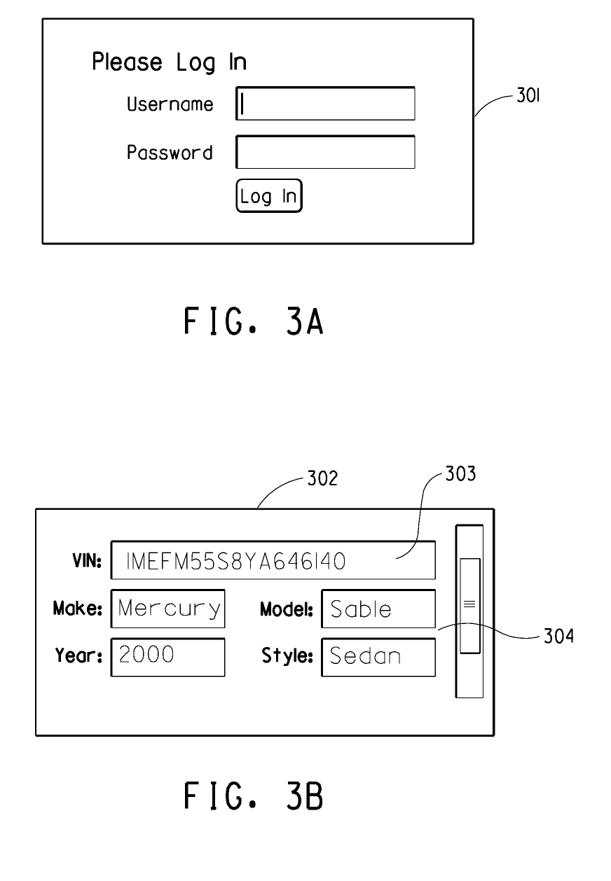

A customer needs to repair his car Mercury Sable (2000) involved in an accident. The customer has an insurance policy from an insurance company that covers the repair with a repair deductable of $500. After reporting the accident to his insurance company, an agent of the insurance company inspects the damage of the car and entered damage data into a database. A claim number is issued to the customer. The customer logs into a claim management system provided by the insurance company from his home computer having internet connection with his Username and Password. An example of a screenshot (301) is shown in FIG. 3A.

The customer then chooses the car to be repaired by using the claim number provided by the insurance company, or by selecting the date of the accident, or by descriptions of the car. Damage data of the car that have been entered by the agent can be displayed on his computer's screen. FIG. 3B shows a screenshot (302) showing some of the data about the car, such as the VIN (303), make, year, model, and style (304).

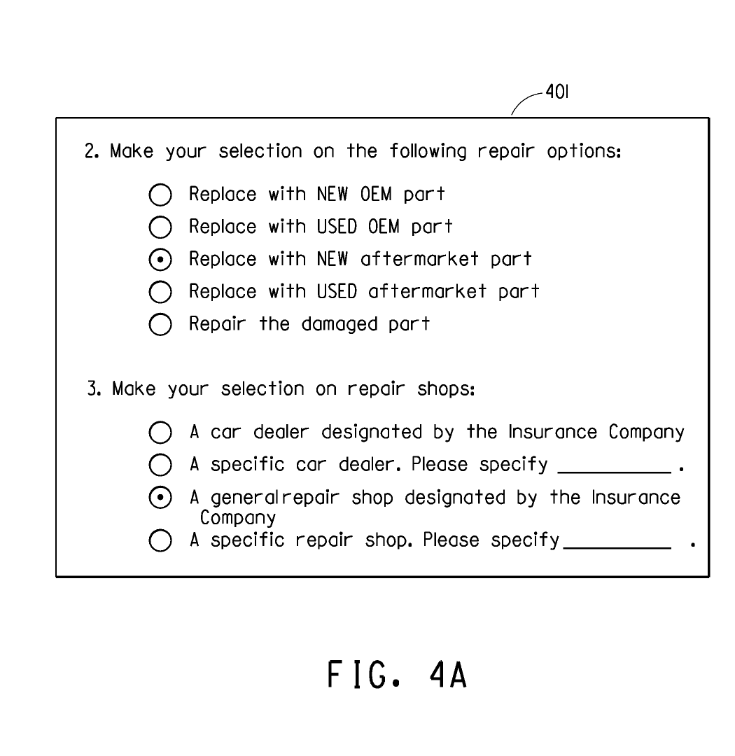

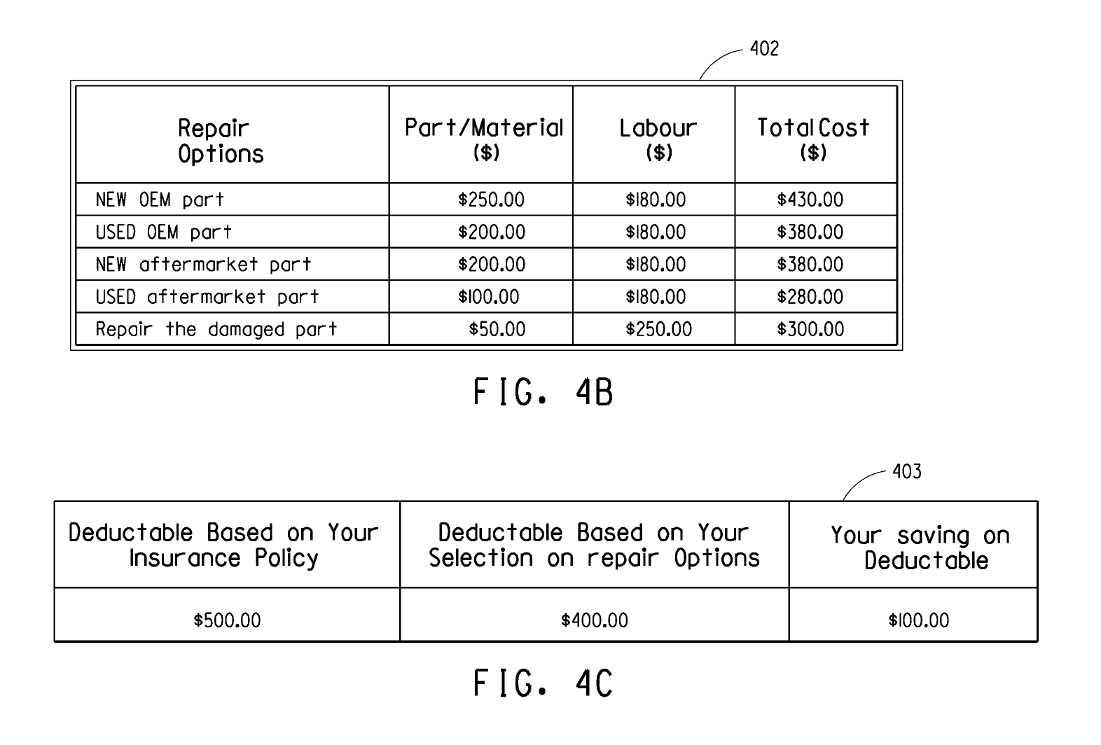

The customer then makes his selections on repair options including parts selection and repair shop selection (401) (FIG. 4). Prices for parts are displayed on the computer screen (402). The customer selects “Replacing with NEW aftermarket part” as his repair selection for damaged wheels. This selection reduces repair cost by about $50. The customer then selects other repair options as recommended by the standard repairs for other damages. The total repair cost is estimated as about $3,000.

The vehicle Mercury Sable (2000) is a mid sized car. The customer can choose a similar mid sized vehicle as a rental car while his car is being repaired. The customer chooses a compact car instead that has a daily rental cost of $5 less than a midsized rental car. Since the repair is expected to last for about 10 days, this selection results in a total rental car cost reduction in the amount of about $50.

After the customer makes and submits his selections to the system, the claim management system generates and displays a modified deductable as $400 based on the insurance policy and his repair selections (403).

The customer then confirms the selection. A repair estimate is then generated by the system that includes the estimated repair cost of $3,000 and rental cost of about $250. The repair estimate can further includes taxes, regulatory fees, disposal fees and other charges that commonly associated with the repair.

What is claimed is:

1. A process for managing claims to repair an article of a customer, said process comprising the steps of:
(i) authorizing the customer to access a claim management system through a computing device based on identification data of the customer, wherein the customer holds an insurance policy from an insurance company;
(ii) obtaining damage data of the article, wherein said article is covered by said insurance policy;
(iii) retrieving a repair deductable according to the insurance policy from an insurance database accessible from the computing device;
(iv) generating and displaying repair data on a display device coupled to the computing device, said repair data comprise standard repair cost and repair options based on the damage data and the insurance policy;
(v) obtaining repair selections from the customer on one or more of said repair options to generate a customer repair selection;
(vi) calculating a customer repair cost based on the customer repair selection;
(vii) generating a modified deductable based on the standard repair cost and the customer repair cost, wherein said modified deductable is less than said repair deductable if the customer repair cost is less than the standard repair cost;
(viii) generating a repair estimate based on said customer repair selection, said customer repair cost and said modified deductable; and
(ix) displaying on the display device said repair estimate, said customer repair cost and said modified deductable.

2. The process of claim 1 further comprising one or more steps selected from:
(x) sending the repair estimate to a repair shop, an agent of the repair shop, the insurance company, an agent of the insurance company, the customer, an agent of the customer, or a combination thereof;
(xi) obtaining a repair report from the repair shop and optionally sending said repair report to the customer;
(xii) obtaining an insurance claim report from the insurance company and optionally sending the insurance report to said customer;
(xiii) generating a part list based on the customer repair selection and sending the part list to one or more part suppliers;
(xiv) generating an article rental request based on the customer repair selection and sending the article rental request to a rental company;
(xv) obtaining a rental report from said rental company and optionally sending the rental report to said customer;
(xvi) obtaining repair approval from said insurance company; or
(xvii) a combination thereof.

3. The process of claim 1, wherein said repair data further comprise the identification data of the customer.

4. The process of claim 1, wherein said repair options comprise one or more options selected from: repair shop selection, repair part selection, article rental selection, or a combination thereof.

5. The process of claim 1 or 2, wherein said article is a vehicle or a vehicle part.

6. The process of claim 1 or 2, wherein said damage data comprises paint data.

7. A computing program product stored in a computer readable storage medium, said computing program product when installed on or functionally coupled to a computing device causes the computing device to perform a computing process comprising the steps of:
(i) authorizing a customer to access the claim management system through said computing device based on identification data of the customer, wherein the customer holds an insurance policy from an insurance company;
(ii) receiving damage data of an article of the customer, wherein said article is covered by said insurance policy;
(iii) retrieving a repair deductable according to the insurance policy from an insurance database accessible from the computing device;
(iv) generating and displaying on a display device coupled to the computing device repair data comprising a repair deductable, standard repair cost, and repair options based on the damage data and the insurance policy;
(v) receiving repair selections on one or more of said repair options to generate a customer repair selection;
(vi) calculating a customer repair cost based on the customer repair selection;
(vii) generating a modified deductable based on the standard repair cost and the customer repair cost, wherein said modified deductable is less than said repair deductable if the customer repair cost is less than the standard repair cost;
(viii) generating a repair estimate based on said customer repair selection, said customer repair cost and said modified deductable; and
(ix) displaying on said display device said repair estimate, said customer repair cost and said modified deductable.

8. The computing program product of claim 8, wherein said computing process further comprises one or more steps selected from:
(x) sending the repair estimate to a repair shop, an agent of the repair shop, the insurance company, an agent of the insurance company, the customer, an agent of the customer, or a combination thereof;
(xi) obtaining a repair report from the repair shop and optionally sending said repair report to the customer;
(xii) obtaining an insurance claim report from the insurance company and optionally sending the insurance report to said customer;
(xiii) generating a part list based on the customer repair selection and sending the part list to one or more part suppliers;
(xiv) generating an article rental request based on the customer repair selection and sending the article rental request to a rental company;
(xv) obtaining a rental report from said rental company and optionally sending the rental report to said customer;
(xvi) obtaining repair approval from said insurance company; or
(xvii) a combination thereof.

9. The computing program product of claim 7, wherein said repair data further comprise the identification data of the customer.

10. The computing program product of claim 7, wherein said repair options comprise one or more options selected from: repair shop selection, repair part selection, article rental selection, or a combination thereof.

11. The computing program product of claim 7 or 8, wherein said article is a vehicle or a vehicle part.

12. The computing program product of claim 7 or 8, wherein said damage data comprises paint data.

13. A claim management system comprising a computing program product and a computing device, said computing program product when installed on or functionally coupled to the computing device causes the computing device to perform a computing process comprising the steps of:
(i) authorizing a customer to access the claim management system through said computing device based on identification data of the customer, wherein the customer holds an insurance policy from an insurance company;
(ii) receiving damage data of an article of the customer, wherein said article is covered by said insurance policy;
(iii) retrieving a repair deductable according to the insurance policy from an insurance database accessible from the computing device;
(iv) generating and displaying on a display device coupled to the computing device repair data comprising a repair deductable, standard repair cost, and repair options based on the damage data and the insurance policy;
(v) receiving repair selections on one or more of said repair options to generate a customer repair selection;
(vi) calculating a customer repair cost based on the customer repair selection;
(vii) generating a modified deductable based on the standard repair cost and the customer repair cost, wherein said modified deductable is less than said repair deductable if the customer repair cost is less than the standard repair cost;
(viii) generating a repair estimate based on said customer repair selection, said customer repair cost and said modified deductable; and
(ix) displaying on said display device said repair estimate, said customer repair cost and said modified deductable.

14. The claim management system of claim 13, wherein said computing process further comprises one or more steps selected from:
(x) sending the repair estimate to a repair shop, an agent of the repair shop, the insurance company, an agent of the insurance company, the customer, an agent of the customer, or a combination thereof;
(xi) obtaining a repair report from the repair shop and optionally sending said repair report to the customer;
(xii) obtaining an insurance claim report from the insurance company and optionally sending the insurance report to said customer;
(xiii) generating a part list based on the customer repair selection and sending the part list to one or more part suppliers;
(xiv) generating an article rental request based on the customer repair selection and sending the article rental request to a rental company;
(xv) obtaining a rental report from said rental company and optionally sending the rental report to said customer;
(xvi) obtaining repair approval from said insurance company; or
(xvii) a combination thereof.

15. The claim management system of claim 13, wherein said storage medium is selected from: an optical memory device, non-volatile computer memory device, volatile storage device, or a combination thereof.

16. The claim management system of claim 13, wherein the computing device is a client computing device functionally communicating with a host computing device through a network device.

17. The claim management system of claim 16, wherein said computing program product resides on a memory device of said host computing device.

18. The claim management system of claim 13, wherein said network device is selected from a wired network device, a wireless network device, or a combination thereof.

19. The claim management system of claim 13, wherein said computing device is a portable computing device.

20. The claim management system of claim 13 further comprising one or more databases comprising data of insurance companies, insurance policies, and deductibles related to said insurance policies, wherein said databases are accessible from said computing device.

21. The claim management system of claim 13, wherein said repair data further comprise the identification data of the customer.

22. The claim management system of claim 13 or 14, wherein said article is a vehicle or a vehicle part.

23. The claim management system of claim 13 or 14, wherein said damage data comprises paint data.
